(19) United States
(12) Patent Application Publication
(10) Pub. No.: US 2014/0143023 A1
(43) Pub. Date: May 22, 2014

(54) ALIGNING ANALYTICAL METRICS WITH STRATEGIC OBJECTIVES

(71) Applicant: INTERNATIONAL BUSINESS MACHINES CORPORATION, Armonk, NY (US)

(72) Inventors: FRANCIS X. REDDINGTON, SARASOTA, FL (US); NEIL SAHOTA, COSTA MESA, CA (US)

(73) Assignee: INTERNATIONAL BUSINESS MACHINES CORPORATION, ARMONK, NY (US)

(21) Appl. No.: 13/680,489

(22) Filed: Nov. 19, 2012

(51) Int. Cl. G06Q 10/06

(52) U.S. Cl. CPC G06Q 10/0637
USPC 705/7.36

(57) ABSTRACT

Aligning analytical metrics with strategic objectives, including: identifying, by the metric analytics generator engine, measurable metrics associated with a business activity; identifying, by the metric analytics generator engine, one or more strategic objectives associated with the business activity; correlating, by the metric analytics generator engine, the one or more measurable metrics associated with the business activity to the one or more strategic objectives associated with the business activity; and generating, by the metric analytics generator engine, key performance indicator formulas in dependence upon the one or more measurable metrics associated with the business activity and the one or more strategic objectives associated with the business activity.

### BACKGROUND OF THE INVENTION

1. Field of the Invention

The field of the invention is data processing, or, more specifically, methods, apparatus, and products for aligning analytical metrics with strategic objectives.

2. Description of Related Art

Managers and other evaluators of a business entity have metrics they want to see met and will frequently design processes around those metrics. This approach can frequently lead to failure as misguided metrics can drive organizational behavior and adversely create unintentional side effects. Many managers don't understand the consequences of unintended cause and effect as a result of misguided directives. For example the singular focus of increase profits without a known balanced approach, can lead management to concentrate on cutting cost to the point of affecting both employee morale and existing customer satisfaction, and inadvertently decreasing profits in the long run.

### SUMMARY OF THE INVENTION

Methods, apparatus, and products for aligning analytical metrics with strategic objectives, including: identifying, by the metric analytics generator engine, measurable metrics associated with a business activity; identifying, by the metric analytics generator engine, one or more strategic objectives associated with the business activity; correlating, by the metric analytics generator engine, the one or more measurable metrics associated with the business activity to the one or more strategic objectives associated with the business activity; and generating, by the metric analytics generator engine, key performance indicator formulas in dependence upon the one or more measurable metrics associated with the business activity and the one or more strategic objectives associated with the business activity.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in aligning analytical metrics with strategic objectives according to embodiments of the present invention.

FIG. 2 sets forth a flow chart illustrating an example computer-implemented method for aligning analytical metrics with strategic objectives according to embodiments of the present invention.

FIG. 3 sets forth a flow chart illustrating a further example computer-implemented method for aligning analytical metrics with strategic objectives according to embodiments of the present invention.

### DETAILED DESCRIPTION OF EXAMPLE EMBODIMENTS

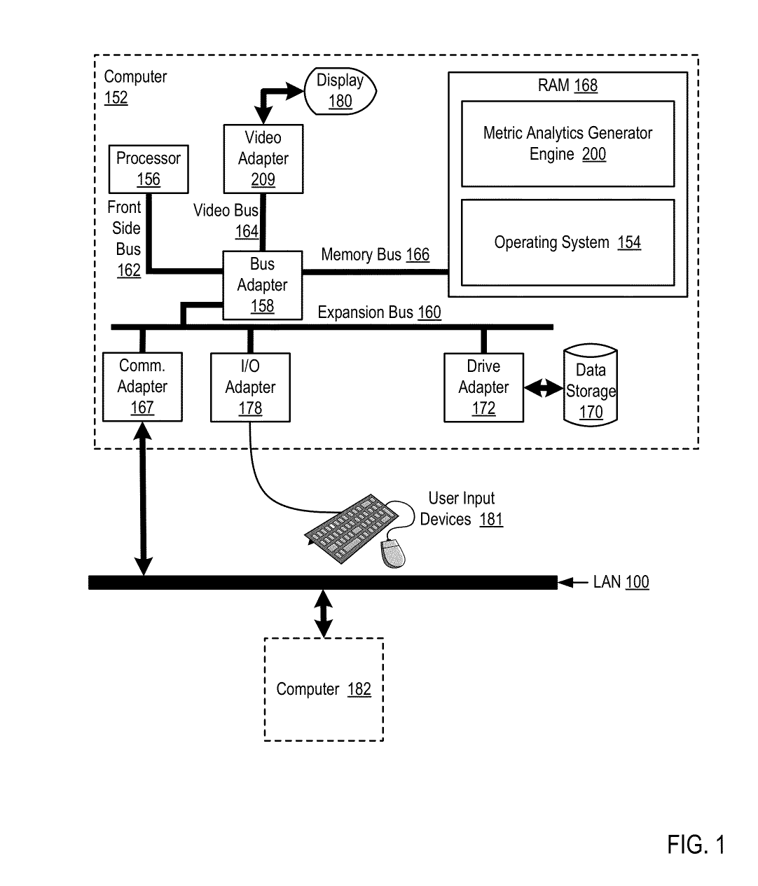

Example methods, apparatus, and products for aligning analytical metrics with strategic objectives in accordance with the present invention are described with reference to the accompanying drawings, beginning with FIG. 1. FIG. 1 sets forth a block diagram of automated computing machinery comprising an example computer (152) useful in aligning analytical metrics with strategic objectives according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a metric analytics generator engine (200), a module of computer program instructions improved for aligning analytical metrics with strategic objectives according to embodiments of the present invention. In the example of FIG. 1, the metric analytics generator engine (200) can carry out aligning analytical metrics with strategic objectives by identifying measurable metrics associated with the business activity. Measurable metrics associated with the business activity can include any quantifiable aspect of a business activity.

In the example of FIG. 1, the metric analytics generator engine (200) can further carry out aligning analytical metrics with strategic objectives by identifying one or more strategic objectives associated with the business activity. The strategic objectives associated with the business activity represent goals that a business entity carrying out the business activity attempts to accomplish.

In the example of FIG. 1, the metric analytics generator engine (200) can further carry out aligning analytical metrics with strategic objectives by correlating the one or more measurable metrics associated with the business activity to the one or more strategic objectives associated with the business activity. Each correlation between a measurable metric and a strategic objective represents a relationship between the measurable metric and the strategic objective such that a change to the value of the measurable metric impacts the ability of a business entity to achieve its strategic objectives. By correlating a particular measurable metric to a plurality of strategic objectives, a business entity may gain a broader understanding of the impact that the particular measurable metric has on its business as a whole—not just an understanding of the impact that the particular measurable metric has on a single strategic objective.

In the example of FIG. 1, the metric analytics generator engine (200) can further carry out aligning analytical metrics with strategic objectives by generating key performance indicator formulas in dependence upon the one or more measurable metrics associated with the business activity and the one or more strategic objectives associated with the business activity. Each key performance indicator formula represents a mathematical function that can be used to determine how well a business entity is accomplishing its strategic objectives. The key performance indicator formulas may include relative weightings such that some key performance indicators are weighted more heavily to the score generated by key performance indicator formula.

Also stored in RAM (168) is an operating system (154). Operating systems useful aligning analytical metrics with strategic objectives according to embodiments of the present invention include UNIX™, Linux™, Microsoft XP™, AIX™, IBM's i5/OS™, and others as will occur to those of skill in the art. The operating system (154) and metric analytics generator engine (200) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for aligning analytical metrics with strategic objectives according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for aligning analytical metrics with strategic objectives according to embodiments of the present invention include modems for wired dial-up communications, Ethernet (IEEE 802.3) adapters for wired data communications network communications, and 802.11 adapters for wireless data communications network communications.

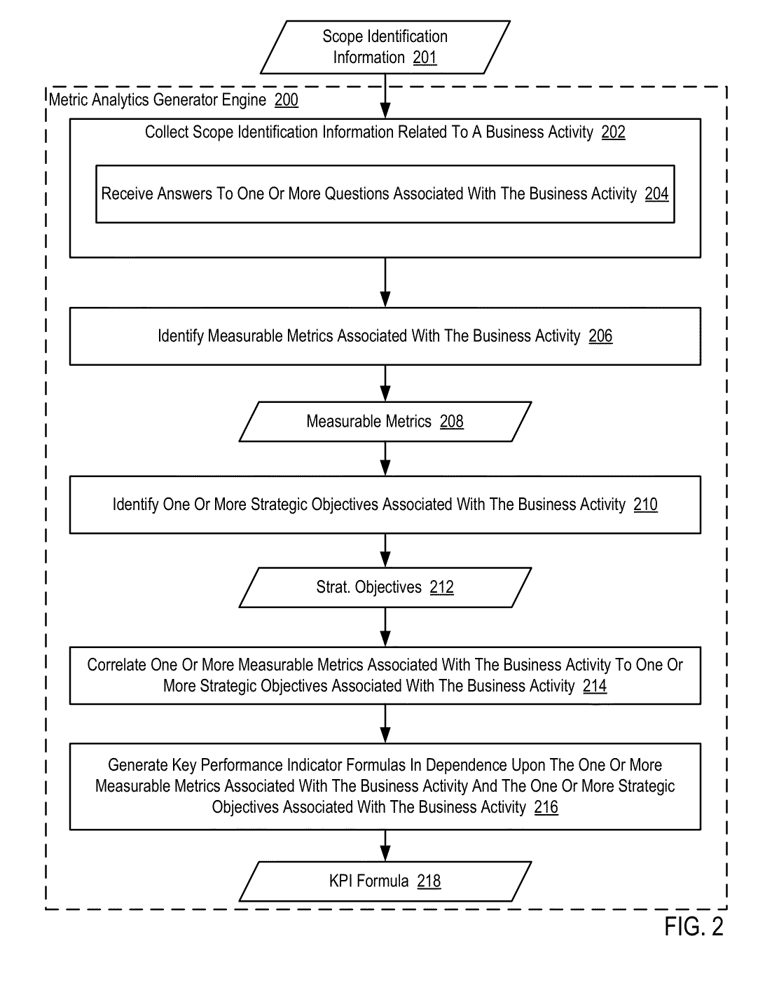

For further explanation, FIG. 2 sets forth a flow chart illustrating an example computer-implemented method for aligning analytical metrics with strategic objectives according to embodiments of the present invention. In the example method of FIG. 2, aligning analytical metrics with strategic objectives is carried out a metric analytics generator engine (200). In the example method of FIG. 2, the metric analytics generator engine (200) may be embodied as a special purpose module of computer program instructions executed on computer hardware such as, for example, a computer processor.

The example method of FIG. 2 includes collecting (202), by the metric analytics generator engine (200), scope identification information (201) related to a business activity. In the example method of FIG. 2, the scope identification information (201) includes information describing various aspects of a business activity. Consider an example in which the business activity is the activity of manufacturing widgets. In such an example, the scope identification information (201) can include information describing various aspects of the activity of manufacturing widgets. For example, the scope identification information (201) can include information identifying who creates a widget, how long it takes to create a widget, what materials are used to create a widget, the amount of each material that used to create a widget, and so on.

In the example method of FIG. 2, collecting (202) scope identification information (201) related to a business activity may be carried by receiving (204) answers to one or more questions associated with the business activity. The answers to one or more questions associated with the business activity may be received (204), for example, through the use of questionnaires in which a business administrator, manager, or other party answers questions related to the business activity. Answers provided in such questionnaires may be analyzed by the metric analytics generator engine (200), for example, through the use of natural language processing techniques. Consider an example in which the questionnaire included a question such as “what are your manufacturing capabilities?” Further assume that the response to such a question stated that “our business can produce 60 widgets per hour.” Through the use of natural language processing techniques and simple mathematical algorithms, the metric analytics generator engine (200) can determine that the length of time required to produce a widget is one minute. Such information can be included in the scope identification information (201).

The example method of FIG. 2 also includes identifying (206), by the metric analytics generator engine (200), measurable metrics (208) associated with the business activity. In the example method of FIG. 2, measurable metrics (208) associated with the business activity can include any quantifiable aspect of a business activity. Consider the example described above in which the business activity is the activity of manufacturing widgets. In such an example, measurable metrics (208) associated with the business activity can include the number of widgets that can be produced in a period of time, the cost of producing a widget, the weight of each widget produced, and so on. In the example method of FIG. 2, identifying (206) measurable metrics (208) associated with the business activity may be carried out, for example, through the use of a user interface that enables a business manager or other user to select from a list of common measurable metrics, by processing information provided in a questionnaire to identify various aspects of a business activity that are associated with a quantifiable value, and so on.

In embodiments of the present application, the measurable metrics (208) associated with the business activity may also be identified (206) based on the general category of the business activity. For example, the metric analytics generator engine (200) may have access to repository that associates measurable metrics with common categories of business activities. In the widget manufacturing example described above, the metric analytics generator engine (200) may classify this business activity into the general category of ‘manufacturing,’ that includes standard measurable metrics such as number of units manufactured per unit of time, the amount of time that manufacturing operations will persist per day, the cost per unit produced, and others as will occur to those of skill in the art.

The example method of FIG. 2 also includes identifying (210), by the metric analytics generator engine (200), one or more strategic objectives (212) associated with the business activity. In the example method of FIG. 2, the strategic objectives (212) associated with the business activity represent goals that a business entity carrying out the business activity attempts to accomplish. Consider the example described above in which the business activity is the activity of manufacturing widgets. In such an example, the strategic objectives (212) associated with the business activity may include reducing the cost for producing each widget, increasing employee retention to avoid losing experienced widget producers, increasing the amount of widgets that are produced within a unit of time, increasing the quality of the widgets produced, and so on. In the example method of FIG. 2, identifying (210) one or more strategic objectives (212) associated with the business activity may be carried out, for example, through the use of a user interface that enables a business manager or other user to select from a list of common strategic objectives, by processing information provided in a questionnaire to identify strategic objectives, and so on.

The example method of FIG. 2 also includes correlating (214), by the metric analytics generator engine (200), the one or more measurable metrics (208) associated with the business activity to the one or more strategic objectives (212) associated with the business activity. In the example method of FIG. 2, each correlation between a measurable metric (208) and a strategic objective (212) represents a relationship between the measurable metric (208) and the strategic objective (212) such that a change to the value of the measurable metric (208) impacts the ability of a business entity to achieve its strategic objectives (212). By correlating (214) a particular measurable metric (208) to a plurality of strategic objectives (212), a business entity may gain a broader understanding of the impact that the particular measurable metric (208) has on its business as a whole—not just an understanding of the impact that the particular measurable metric (208) has on a single strategic objective (212).

Consider the example described above in which the business activity is the activity of manufacturing widgets. In such an example, assume that reducing the cost for producing each widget is one strategic objective that has been identified. Also assume that increasing the employee retention rate is also one strategic objective. In such an example, decreasing the compensation level for each employee would seemingly help achieve one strategic objective (reducing the cost for producing each widget) while also decreasing the likelihood that another strategic objective (increasing the employee retention rate) is achieved. In such an example, by correlating (214) the one or more measurable metrics (208) to the one or more strategic objectives (212), managers within a business entity can better understand the impact of an average employee compensation measurable metric on the business as a whole.

The example method of FIG. 2 also includes generating (216), by the metric analytics generator engine (200), key performance indicator formulas (218) in dependence upon the one or more measurable metrics (208) associated with the business activity and the one or more strategic objectives (212) associated with the business activity. In the example method of FIG. 2, each key performance indicator formula (218) represents a mathematical function that can be used to determine how well a business entity is accomplishing its strategic objectives (212). The key performance indicator formulas (218) may include relative weightings such that some key performance indicators are weighted more heavily to the score generated by key performance indicator formula (218).

Consider the example described above in which the business activity is the activity of manufacturing widgets. In such an example, assume that reducing the cost for producing each widget is one strategic objective and that increasing the employee retention rate is another strategic objective. In such an example, the compensation level for each employee would seemingly help achieve one strategic objective (reducing the cost for producing each widget) while also decreasing the likelihood that another strategic objective (increasing the employee retention rate) is achieved. However, the business may place a higher priority on reducing the cost of materials than reducing the cost of labor as reducing the cost labor has a negative impact on employee retention. In such an example, a key performance indicator formula (218) may therefore place a higher weighting on the cost of materials versus the cost of labor.

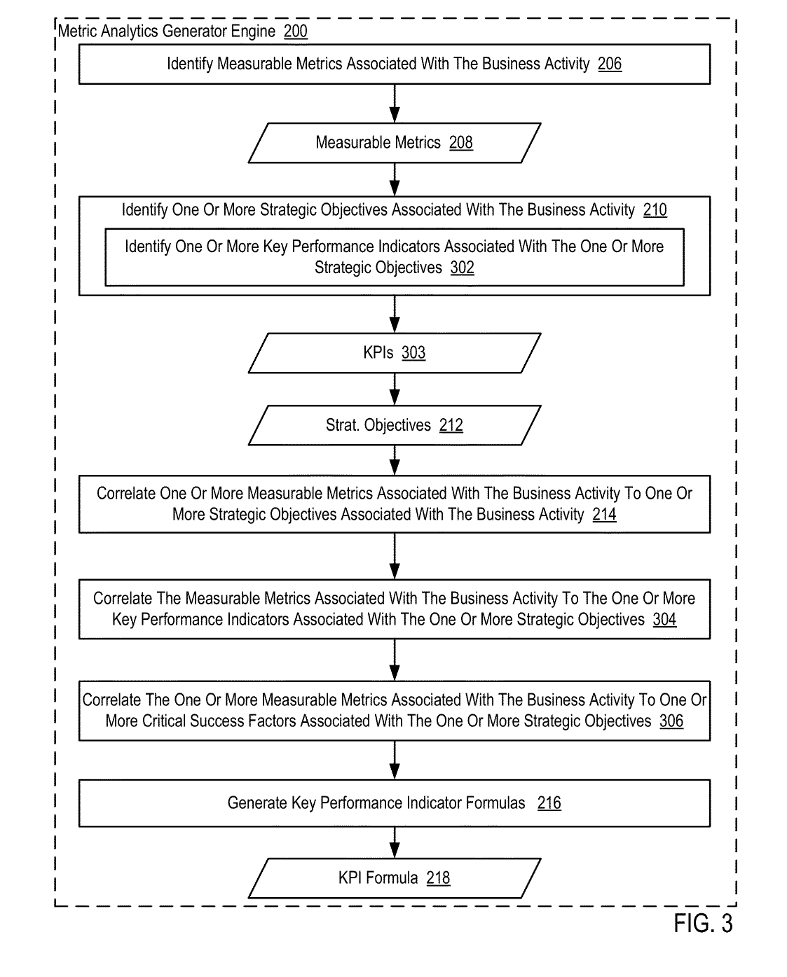

For further explanation, FIG. 3 sets forth a flow chart illustrating a further example computer-implemented method for aligning analytical metrics with strategic objectives according to embodiments of the present invention. The example method of FIG. 3 is similar to the example method of FIG. 2 as it also includes identifying (206) measurable metrics (208) associated with the business activity, identifying (210) one or more strategic objectives (212) associated with the business activity, correlating (214) the one or more measurable metrics (208) associated with the business activity to the one or more strategic objectives (212) associated with the business activity, and generating (216) key performance indicator formulas (218) in dependence upon the one or more measurable metrics (208) associated with the business activity and the one or more strategic objectives (212) associated with the business activity.

In the example method of FIG. 3, identifying (210) one or more strategic objectives (212) associated with the business activity includes identifying (302) one or more key performance indicators (303) associated with the one or more strategic objectives (212). In the example method of FIG. 3, the key performance indicators (303) represent performance measurements that may be used by an organization to evaluate its success or the success of an activity in which the organization is engaged. The key performance indicators (303) of FIG. 3 can be associated with the one or more strategic objectives (212) in the sense that the key performance indicators (303) may be used to determine whether the one or more strategic objectives (212) are being achieved. That is, the one or more strategic objectives (212) may be achieved by meeting measurable goals as indicated by the key performance indicators (303). In the example method of FIG. 3, the key performance indicators (303) may be linked to target values such that the value of the measure can be assessed as meeting expectations or not meeting expectations. Consider the widget manufacturing described above in which a strategic objective is to increase manufacturing efficiency. In such an example, the amount of time required to produce each widget could be one key performance indicator what while the rejection rate (i.e., the percentage of produced widgets that defective) could be another key performance indicator.

The example method of FIG. 3 also includes correlating (304), by the metric analytics generator engine (200), the one or more measurable metrics (208) associated with the business activity to the one or more key performance indicators (303) associated with the one or more strategic objectives (212). A measurable metric (208) may be correlated (304) to a particular key performance indicator (303) when the metric can be used to determine the value of the key performance indicator (303). Consider the example described above in which the rejection rate of manufacturing widgets is a key performance indicator. In such an example, a measurable metric that identifies the number of acceptable widgets that were produced in a unit of time could be associated with the key performance indicator, and a measurable metric that identifies the number of defective widgets that were produced in the same unit of time could also be associated with the key performance indicator. In such an example, determining a value for the ‘rejection rate’ key performance indicator could be carried out by dividing the number of defective widgets by the sum of the number of defective widgets and the number of acceptable widgets that were produced during the measurement period.

The example method of FIG. 3 also includes correlating (306), by the metric analytics generator engine (200), the one or more measurable metrics (208) associated with the business activity to one or more critical success factors associated with the one or more strategic objectives (208). In the example method of FIG. 3, critical success factors associated with the one or more strategic objectives (208) represent an element that is necessary for an organization or project to achieve its mission. Such critical success factors are vital for a strategy to be successful and can drive the strategy forward as these factors can make or break the success of the strategy. Consider the example described above in which the business activity is the activity of manufacturing widgets. Assume that on-time fulfillment of customer orders is deemed to be a critical success factor and the business can succeed or fail based on customer satisfaction. In such an example, those measurable metrics (208) that are related to on-time fulfillment of customer orders such as, for example, shipping time, manufacturing time, and other may be correlated (306) to such a critical success factor.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of aligning analytical metrics with strategic objectives, the method comprising:
identifying, by the metric analytics generator engine, measurable metrics associated with a business activity;
identifying, by the metric analytics generator engine, one or more strategic objectives associated with the business activity;
correlating, by the metric analytics generator engine, the one or more measurable metrics associated with the business activity to the one or more strategic objectives associated with the business activity; and
generating, by the metric analytics generator engine, key performance indicator formulas in dependence upon the one or more measurable metrics associated with the business activity and the one or more strategic objectives associated with the business activity.

2. The method of claim 1 further comprising collecting, by a metric analytics generator engine, scope identification information related to the business activity.

3. The method of claim 2 wherein collecting scope identification information related to the business activity includes receiving, by the metric analytics generator engine, answers to one or more questions associated with the business activity.

4. The method of claim 1 wherein identifying, by the metric analytics generator engine, one or more strategic objectives associated with the business activity further comprises identifying one or more key performance indicators associated with the one or more strategic objectives.

5. The method of claim 4 further comprising correlating, by the metric analytics generator engine, the one or more measurable metrics associated with the business activity to the one or more key performance indicators associated with the one or more strategic objectives.

6. The method of claim 1 further comprising correlating, by the metric analytics generator engine, the one or more measurable metrics associated with the business activity to one or more critical success factors associated with the one or more strategic objectives.

7. An apparatus for aligning analytical metrics with strategic objectives, the apparatus comprising a computer processor, a computer memory operatively coupled to the computer processor, the computer memory having disposed within it computer program instructions that, when executed by the computer processor, cause the apparatus to carry out the steps of:
identifying, by the metric analytics generator engine, measurable metrics associated with a business activity;
identifying, by the metric analytics generator engine, one or more strategic objectives associated with the business activity;
correlating, by the metric analytics generator engine, the one or more measurable metrics associated with the business activity to the one or more strategic objectives associated with the business activity; and
generating, by the metric analytics generator engine, key performance indicator formulas in dependence upon the one or more measurable metrics associated with the business activity and the one or more strategic objectives associated with the business activity.

8. The apparatus of claim 7 further comprising computer program instructions that, when executed by the computer processor, cause the apparatus to carry out the step of collecting, by a metric analytics generator engine, scope identification information related to the business activity.

9. The apparatus of claim 8 wherein collecting scope identification information related to the business activity includes receiving, by the metric analytics generator engine, answers to one or more questions associated with the business activity.

10. The apparatus of claim 7 wherein identifying, by the metric analytics generator engine, one or more strategic objectives associated with the business activity further comprises identifying one or more key performance indicators associated with the one or more strategic objectives.

11. The apparatus of claim 10 further comprising computer program instructions that, when executed by the computer processor, cause the apparatus to carry out the step of correlating, by the metric analytics generator engine, the one or more measurable metrics associated with the business activity to the one or more key performance indicators associated with the one or more strategic objectives.

12. The apparatus of claim 7 further comprising computer program instructions that, when executed by the computer processor, cause the apparatus to carry out the step of correlating, by the metric analytics generator engine, the one or more measurable metrics associated with the business activity to one or more critical success factors associated with the one or more strategic objectives.

13. A computer program product for aligning analytical metrics with strategic objectives, the computer program product disposed upon a computer readable medium, the computer program product comprising computer program instructions that, when executed, cause a computer to carry out the steps of:
identifying, by the metric analytics generator engine, measurable metrics associated with a business activity;
identifying, by the metric analytics generator engine, one or more strategic objectives associated with the business activity;
correlating, by the metric analytics generator engine, the one or more measurable metrics associated with the business activity to the one or more strategic objectives associated with the business activity; and
generating, by the metric analytics generator engine, key performance indicator formulas in dependence upon the one or more measurable metrics associated with the business activity and the one or more strategic objectives associated with the business activity.

14. The computer program product of claim 13 further comprising computer program instructions that, when executed, cause the computer to carry out the step of collecting, by a metric analytics generator engine, scope identification information related to the business activity.

15. The computer program product of claim 14 wherein collecting scope identification information related to the business activity includes receiving, by the metric analytics generator engine, answers to one or more questions associated with the business activity.

16. The computer program product of claim 13 wherein identifying, by the metric analytics generator engine, one or more strategic objectives associated with the business activity further comprises identifying one or more key performance indicators associated with the one or more strategic objectives.

17. The computer program product of claim 16 further comprising computer program instructions that, when executed, cause the computer to carry out the step of correlating, by the metric analytics generator engine, the one or more measurable metrics associated with the business activity to the one or more key performance indicators associated with the one or more strategic objectives.

18. The computer program product of claim 13 further comprising computer program instructions that, when executed, cause the computer to carry out the step of correlating, by the metric analytics generator engine, the one or more measurable metrics associated with the business activity to one or more critical success factors associated with the one or more strategic objectives.

19. The computer program product of claim 13 wherein the computer readable medium comprises a signal medium.

20. The computer program product of claim 13 wherein the computer readable medium comprises a storage medium.
